(19) United States
(12) Patent Application Publication
(10) Pub. No.: US 2023/0198207 A1
(43) Pub. Date: Jun. 22, 2023

(54) ONE ESD SELF-PROTECT METHOD FOR CONNECTOR

(71) Applicant: Advanced Micro Devices, Inc., Santa Clara, CA (US)

(72) Inventors: Lin Wang, Shanghai (CN); Yuyang Jiang, Shanghai (CN); Xiaohua Wang, Shanghai (CN); Kaichun Ning, Shanghai (CN)

(21) Appl. No.: 17/554,868

(22) Filed: Dec. 17, 2021

(51) Int. Cl. H01R 13/648

(52) U.S. Cl. CPC H01R 13/6485

(57) ABSTRACT

A system and method for efficient methods and systems for input/output port protection from electrostatic discharge events are described. In various implementations, an integrated circuit mounted on a printed circuit board includes a connector port that uses a first signal pin within a metal shell mounted on the printed circuit board and is electrically connected to a ground reference. The first signal pin is electrically connected to the ground reference though a spring pin located between itself and the shell. A user inserts a head contact of a cable into the connector port. The head contact includes a second signal pin that is floating, but becomes connected to the ground reference when brought into physical contact with the first signal pin. During later insertion, the head contact pushes the spring pin causing physical disconnection of the spring pin from the first signal pin allowing data transmission to begin.

### BACKGROUND

### Description of the Relevant Art

When two nodes have a different electrical potential, such as different electrical charge accumulation, and the two nodes are electrically connected, an electrostatic discharge (ESD) occurs. Current flows and seeks a low impedance path from the higher potential node to a ground reference voltage level. In one example, a user inserts a head contact of a cable into a connector port of an input/output interface of a computing system, and it is possible that electrical charge had accumulated on the skin, which causes the electrostatic discharge event. The circuitry of ESD protection components are used to provide a lowest impedance path to the ground reference voltage level, which protect circuits of an input/output interface and one or more functional blocks of an integrated circuit connected to the input/output interface. These ESD protection components are located near the input/output interface of the integrated circuit. However, as signal rates increase through the input/output interface, these ESD protection components increase transmission line loss and reduce signal integrity. It is desired to have a method to both provide ESD protection for circuit nodes without introducing insertion loss.

In view of the above, efficient methods and systems for input/output (I/O) port protection from electrostatic discharge events are desired.

### BRIEF DESCRIPTION OF THE DRAWINGS

FIG. 1 is a generalized diagram of a computing system.

FIG. 2 is a generalized diagram of a connector port on a printed circuit board.

FIG. 3 is a generalized diagram of an input/output interface.

FIG. 4 is a generalized diagram of an input/output interface.

FIG. 5 is a generalized diagram of an input/output interface.

FIG. 6 is a generalized diagram of an input/output interface.

FIG. 7 is a generalized diagram of an input/output interface.

FIG. 8 is a generalized diagram of an input/output interface.

FIG. 9 is a generalized diagram of one implementation of a method for efficiently providing input/output port protection from electrostatic discharge events.

FIG. 10 is a generalized diagram of one implementation of a method for efficiently providing input/output port protection from electrostatic discharge events.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Systems and methods for efficiently providing input/output port protection from electrostatic discharge events are contemplated. In various implementations, an integrated circuit mounted on a printed circuit board includes one or more functional blocks. The integrated circuit also includes an input/output interface with a connector port that communicates with a peripheral device through a link between the peripheral device and the connector port. The link includes a head contact of a cable that is inserted into the connector port by a user. The connector port uses multiple signal pins within a metal shell mounted on the printed circuit board. The multiple signal pins are connected to one or more of the functional blocks of the integrated circuit. The shell is electrically connected to a ground reference voltage level of the printed circuit board. At least a first signal pin of the multiple signal pins is electrically connected to the ground reference voltage level though a spring pin located between the shell and the first signal pin. Therefore, the first signal pin is not floating.

A user inserts the head contact of the cable into the connector port. The head contact of the cable is associated with a display connector, a Universal Serial Bus (USB) link, or other. The head contact includes multiple signal pins including a second signal pin that is floating. As the user inserts the head contact into the connector port, the second signal pin becomes physically connected to the first signal pin. As a result, the second signal pin is set to the ground reference voltage level and is no longer floating. If there is a difference in electrical potential between the first signal pin and the second signal pin, an electrostatic discharge occurs, and the corresponding current flows through the low impedance path provided by the first signal pin, the spring pin, and the shell connected to the ground reference voltage level. For example, as the second signal pin becomes physically connected to the first signal pin, if the second signal pin has a non-zero electrical potential, whereas, the first signal pin has the ground reference voltage level, then there is a difference in electrical potential that causes the electrostatic discharge to occur. The use of the spring pin provides ESD protection, though.

As the user continues to insert the head contact into the connector port, the head contact is configured to push the spring pin causing physical disconnection of the spring pin from the first signal pin. As a result, the first signal pin is disconnected from the metal shell of the connector port, and each of the first signal pin and the second signal pin remains at a same electrical potential. By being at the same electrical potential, a further electrostatic discharge is unable to occur. At this point in time, the head contact is fully inserted into the connector port, and each of the first signal pin and the second signal pin is available for transmitting data. In some implementations, the functional block that receives the first signal pin does not include electrostatic discharge protection circuitry.

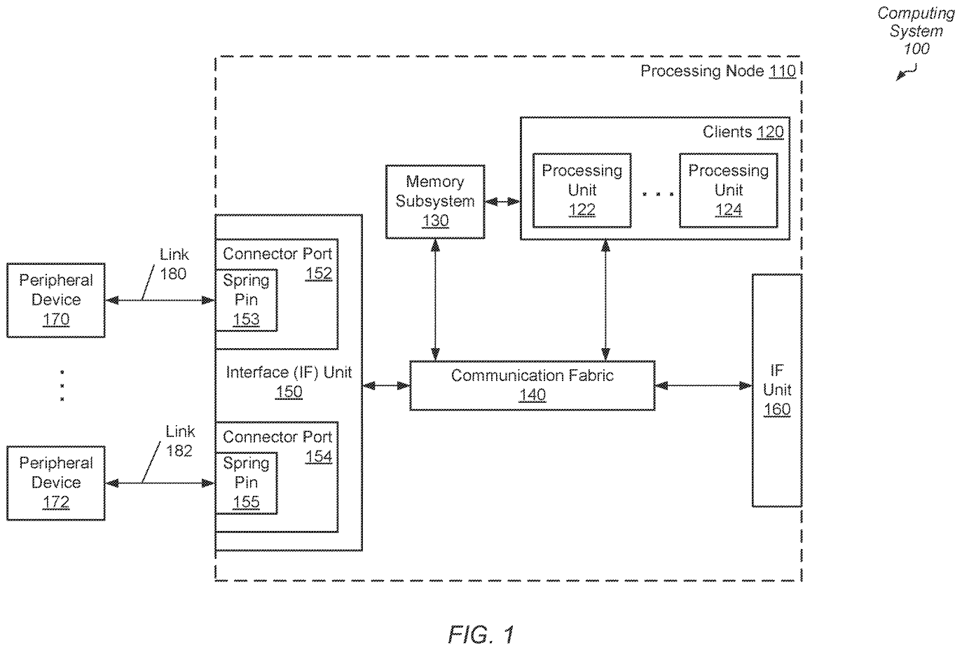

Turning now to FIG. 1, a generalized block diagram is shown of a computing system 100. Computing system 100 includes at least one processing node 110 that is connected to peripheral devices 170-172 through links 180-182. Processing node 110 includes communication fabric 140, clients 120, memory subsystem 130, and interface (IF) units 150 and 160. In some implementations, the components of processing node 110 are individual dies on an integrated circuit (IC), such as a system-on-a-chip (SOC). In other implementations, the components are individual dies in a system-in-package (SiP) or a multi-chip module (MCM), or semiconductor chips on a motherboard or card. This implementation does not include all examples of functional blocks, control logic, and interfaces required both within and outside processing node 110. In other implementations, computing system 100 includes two or more processing nodes 110. The implementation shown is for a simple illustrative purpose.

In the illustrated implementation, clients 120 include multiple processing units 122-124. Examples of processing units 122-124 are a central processing unit (CPU) with circuitry used for processing instructions of a selected instruction set architecture (ISA), a graphics processing unit (GPU) with circuitry that implements a high parallel data microarchitecture, a Hub used for communicating with multimedia engine, and a multimedia engine with circuitry that processes audio data and visual data for multimedia applications. In another implementation, examples of the processing units 122-124 include one or more application specific integrated circuits (ASICs) or microcontrollers, one or more digital signal processors (DSPs), analog-to-digital converters (ADCs), and digital-to-analog converters (DACs). Other data processing semiconductor chip designs included within clients 120 are possible and contemplated. Further, physically, in other implementations, one or more of these data processing designs are implemented outside of processing unit 110 for interfacing reasons, on-die routing and signal integrity reasons, or other reasons.

In some implementations, a cache memory subsystem is implemented as a L1 cache structure integrated within one or more of the processing units 122-124 that stores blocks of data. Memory subsystem 130 is implemented as a L2 or L3 cache structure and is directly coupled to clients 120. In various implementations, communication fabric 140 transfers data back and forth between clients 120, memory subsystem 130, and other external devices via the IF units 150-160. The data being transferred through fabric 450 includes data such as commands, messages, probes, interrupts, and data corresponding to the commands and messages. Interface units 150-160 include circuitry to receive packets and synchronize the packets to an internal clock used by the processing node 110.

Processing node 110 is coupled to one or more peripheral devices 170-172. Depending on the implementation of processing node 110, peripheral devices 170-172 include one or more of portable storage devices, display screens, gamepads, smartphones, personal data assistants (PDAs), portable audio/video players, cameras, or other. The peripheral devices 170-172 consist of several logical sub-devices that are referred to as device functions. A single peripheral device is capable of providing several functions. For example, a portable DVD player has both a video device function and built-in speakers, which is an audio device function. Other devices are contemplated to also be within the scope of the present invention. The specific type of peripheral used does not limit the invention.

As shown, the interface unit 150 includes connector ports 152-154. One or more of the links 182-184 are a cable with a head contact that inserts into a corresponding one of the connector ports 152-154. The links 182-184 and the connector ports 152-154 support data transfer and a communication protocol based on the type of a corresponding one of the peripheral devices 170-172. For example, the link 180 and the connector port 152 support the communication protocol of a serial data communications of a Universal Serial Bus (USB) when the peripheral device 170 is a USB device. Similarly, the link 182 and the connector port 154 support the communication protocol for transferring video data when the peripheral device 172 is a display screen or monitor. In such cases, the link 182 and the connector port 154 support the DisplayPort (DP) specification, the High-Definition Multimedia Interface (HDMI) specification, or other.

The peripheral devices 170-172, the links 182-184 and the connector ports 152-154 typically operate at relatively low voltage levels. Should an overvoltage event occur, then it is possible that one or more of the connector ports 152-154 and the head contact of a cable of the links 182-184 becomes permanently damaged. As described earlier, the link 182 includes a head contact of a cable that is inserted into the connector port 154 by a user. The connector port 154 uses multiple signal pins within a metal shell mounted on a printed circuit board. The multiple signal pins are connected to circuitry of the interface unit 150, which sends the corresponding data to clients 120 through the communication fabric 140.

The metal shell of the connector port 154 is electrically connected to a ground reference voltage level of the printed circuit board. At least one signal pin of the multiple signal pins is electrically connected to the ground reference voltage level though the spring pin 155 located between the shell and the first signal pin. Therefore, this signal pin is not floating. As the head contact of the cable of the link 182 is inserted by the user, the spring pin 155 a signal pin of the head contact physically connects to the signal pin of the connector port 154 and becomes electrically shorted to the ground reference voltage level. Shortly afterwards, the spring pins disconnects from the signal pin of the connector port 154. Since the two signal pins are at a same electrical potential, such as the ground reference voltage level, no electrostatic discharge occurs. In various implementations, the connector port 152 also includes at least one spring pin 153 to prevent a corresponding signal pin from being a floating signal.

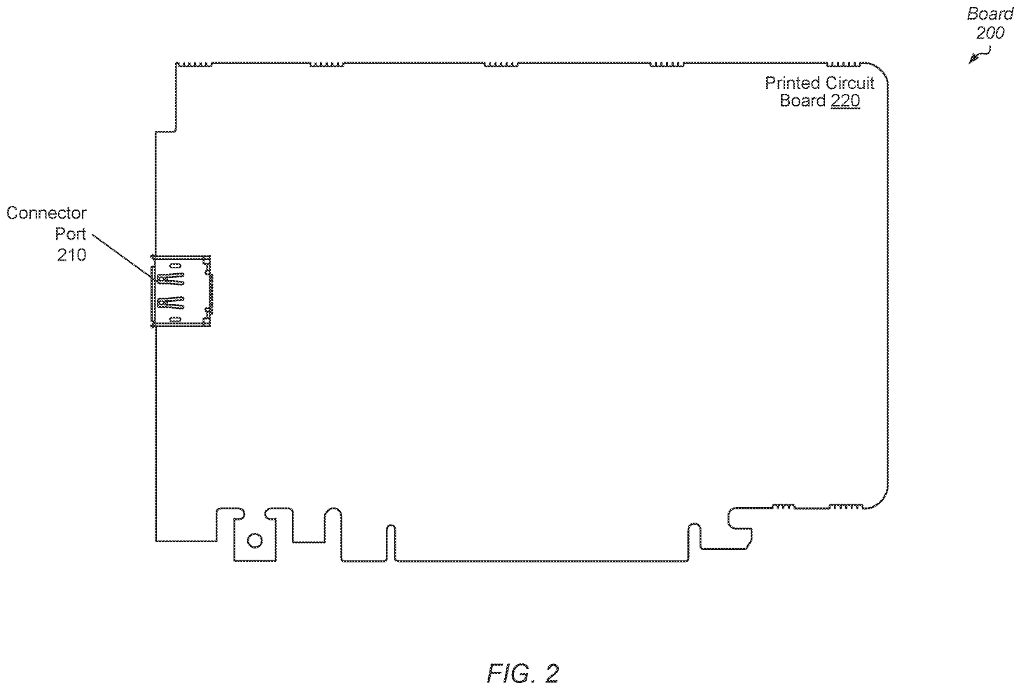

Referring to FIG. 2, a generalized block diagram is shown of a printed circuit board 200. The printed circuit board 220 is representative of one of a variety of printed circuit boards and cards used in a computing system. The connector port 210 is one example of multiple connector ports placed on the printed circuit board 220. The metal shell of the connector port 210 is electrically connected to a ground reference voltage level of the printed circuit board 220.

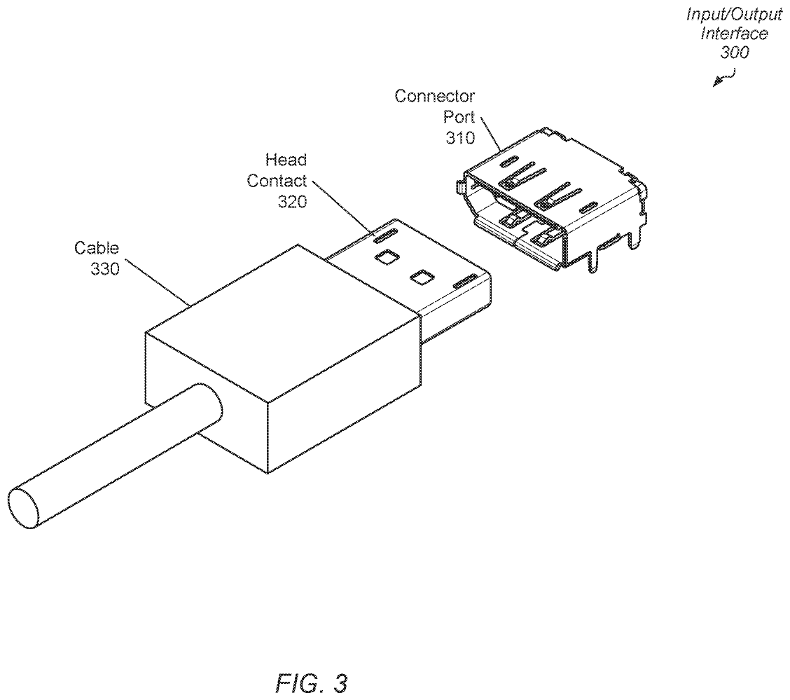

Turning now to FIG. 3, a generalized block diagram is shown of an input/output interface 300. The metal shell of a connector port 310 is shown without the printed circuit board or card for ease of illustration. Inside the connector port 310 are multiple signal pins used to transfer data based on a particular communication protocol. The head contact 320 and the cable 330 provide a link between the connector port 310 and a peripheral device (not shown). Similar to the connector port 310, the head contact 320 also includes multiple signal pins used to transfer data based on a particular communication protocol. A user inserts the head contact 320 into the connector port 310 when connecting the peripheral device to a computing system. The metal shell of the connector port 310 is electrically connected to a ground reference voltage level of the printed circuit board. At least one signal pin of the multiple signal pins of the connector port 310 is electrically connected to the ground reference voltage level though a spring pin inside the connector port 310. The spring pin is located between the metal shell and the signal pin. Therefore, this signal pin is not floating. In some implementations, each of the signal pins of the connector port 310 has a corresponding spring pin.

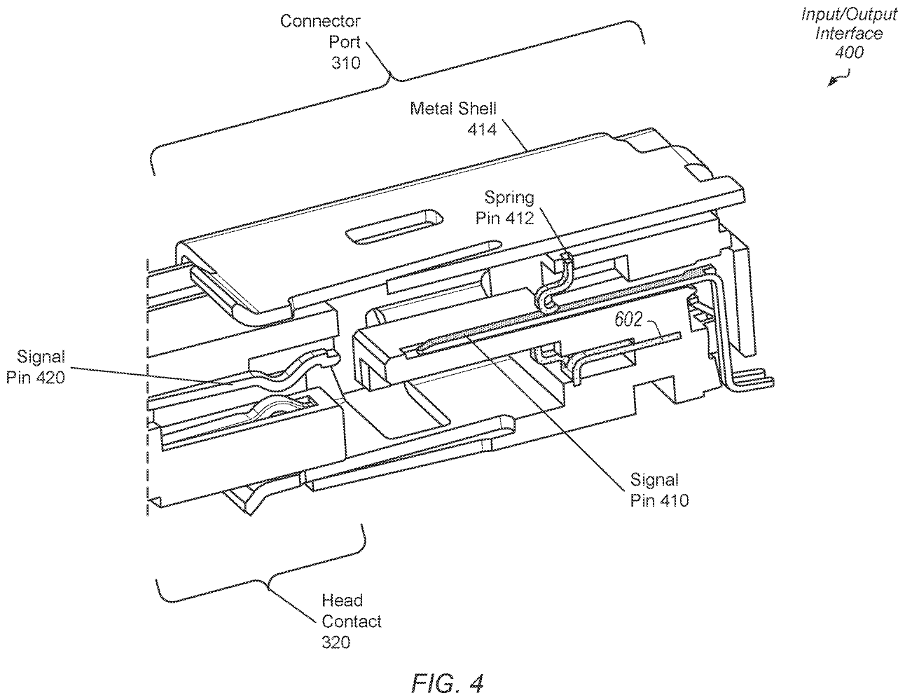

Referring to FIG. 4, a generalized block diagram is shown of an input/output interface 400. Components, structures, and circuits described earlier are numbered identically. The input/output interface 400 includes the head contact 320 being partially inserted in the connector port 310. The connector port 310 includes the metal shell 414 that is connected to the ground reference voltage level of the printed circuit board (not shown). The connector port also includes at least the signal pin 410. Although a single signal pin is shown, the connector port 310 includes any number of signal pins in various implementations. The remainder of the connector port is a body used for physical support and electrical isolation for the signal pins. For example, one of a variety of types of plastics is used.

The connector port 310 additionally includes the spring pin 412. Similar to the signal pin 410, although a single signal pin is shown, the connector port 310 includes any number of spring pins in various implementations. For example, in an implementation, each signal pin of the connector port 310 has a corresponding spring pin. The spring pin 412 is physically connected to each of the metal shell 414 and the signal pin 410. Since the spring pin 412 conducts, the signal pin 410 is electrically connected to the ground reference voltage level of the printed circuit board through the spring pin 412 and the metal shell 414. Therefore, the signal pin 410 is not floating.

The head contact 320 also has a signal pin 420. It is possible and contemplated that the head contact 320 has a same number of signal pins as the connector port 310. In contrast to the signal pin 410, there is no spring pin used with the signal pin 420 of the head contact 320. Therefore, the signal pin 420 is a floating signal. In some implementations, the signal pins 410 and 420 use copper metal or a mixture of copper and other conductive metals. The spring pin 412 uses stainless steel. In one implementation, the spring pin 412 uses the Society of Automotive Engineers (SAE) steel grade 304, which is equivalent to the Asian steel grade of SUS 304. As shown, the head contact 320 is partially inserted in the connector port 310, and the signal pin 420 has not yet made physical contact with the signal pin 410.

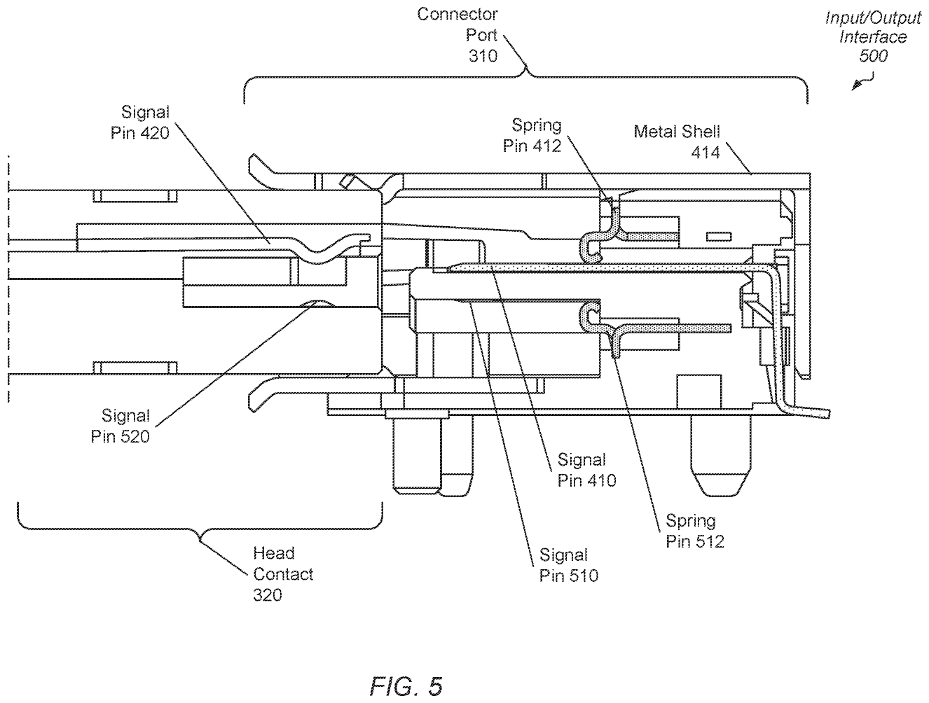

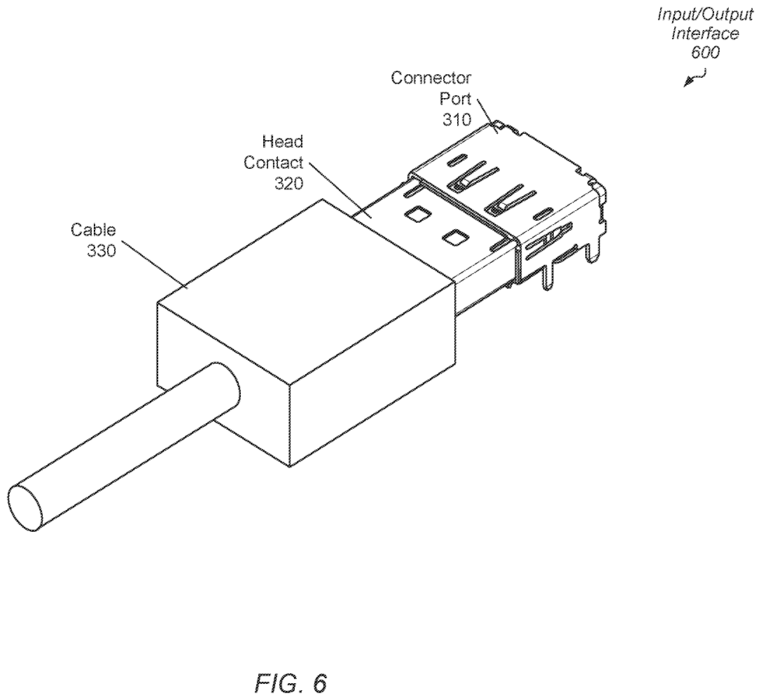

Referring to FIG. 5, a generalized block diagram is shown of an input/output interface 500. Components, structures, and circuits described earlier are numbered identically (as well as for FIGS. 6-8). The input/output interface 500 includes the head contact 320 being partially inserted in the connector port 310. The signal pin 420 has not yet made physical contact with the signal pin 410. In this view, it is shown that connector port 310 also includes the signal pin 510 below signal pin 410. The signal pin 510 is physically disconnected from the signal pin 410. Therefore, the signal pin 510 is able to transfer separate data than data being transferred by signal pin 410. Likewise, the head contact 320 also includes the signal pin 520 below the signal pin 420. When physically connected and data transmission has begun, the signal pin 420 of the head contact 320 transfers data with the signal pin 410 of the connector port 310. Similarly, the signal pin 520 of the head contact 320 is able to transfer data with the signal pin 510 of the connector port 310.

The connector port 310 also includes the spring pin 512. The spring pin 512 is equivalent to the spring pin 412. For example, the spring pin 512 is physically connected to each of the metal shell 414 and the signal pin 510. Since the spring pin 512 conducts, the signal pin 510 is electrically connected to the ground reference voltage level of the printed circuit board through the spring pin 512 and the metal shell 414. Therefore, the signal pin 510 is not floating.

Turning now to FIG. 6, a generalized block diagram is shown of an input/output interface 600. The input/output interface 600 includes the head contact 320 being further inserted in the connector port 310. For example, the signal pins of the head contact 320 and the connector port 310 are able to be physically connected to one another.

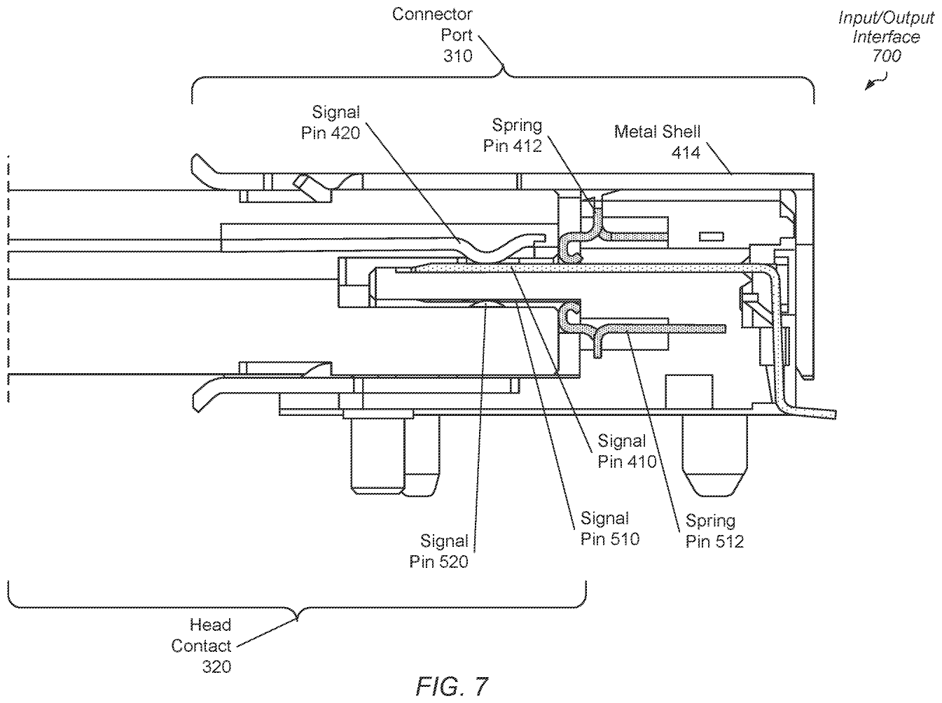

Referring to FIG. 7, a generalized block diagram is shown of an input/output interface 700. The input/output interface 700 includes the head contact 320 being more fully inserted in the connector port 310. The signal pin 420 has made physical contact with the signal pin 410. Similarly, the signal pin 520 has made physical contact with the signal pin 510. As a result, the signal pin 420 is electrically connected to the ground reference voltage level of the printed circuit board through the signal pin 410, the spring pin 412, and the metal shell 414. The signal pin 420 is no longer floating. Similarly, the signal pin 520 is electrically connected to the ground reference voltage level of the printed circuit board through the signal pin 510, the spring pin 512, and the metal shell 414. The signal pin 520 is no longer floating.

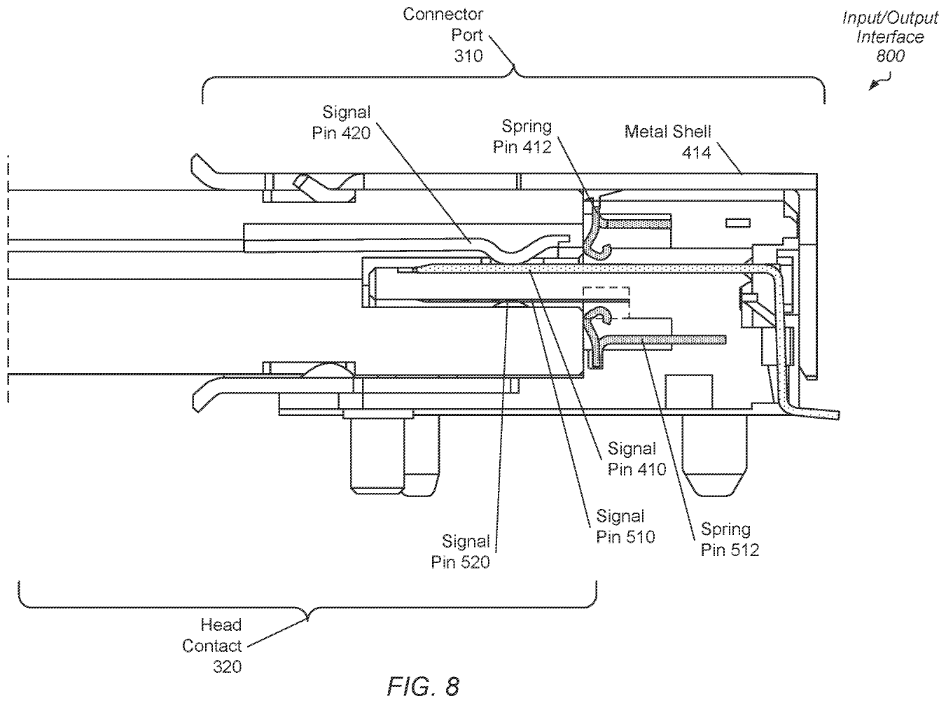

Referring to FIG. 8, a generalized block diagram is shown of an input/output interface 800. The input/output interface 800 includes the head contact 320 being fully inserted in the connector port 310. The signal pin 420 has made physical contact with the signal pin 410, and the body or housing of the head contact 320 has pushed the spring pin 412 causing the spring pin 412 to be physically disconnected from the signal pin 410. Therefore, each of the signal pins 410 and 420 is at a same electrical potential, but is no longer electrically connected to the metal shell 414. Similarly, the body or housing of the head contact 320 has pushed the spring pin 512 causing the spring pin 512 to be physically disconnected from the signal pin 510. The dashed box shows an opening in the housing of the connector port, which allows a view of the spring pin 512 being physically disconnected from the signal pin 510. Therefore, the signal pins 510 and 520 are set at a same electrical potential as a corresponding one of the signal pins 410 and 412, but is no longer electrically connected to the metal shell 414. At this point in time, each of the signal pins, 410, 420, 510 and 520 is available for transmitting data. In some implementations, one or more of the interface unit and functional blocks in a chip on the printed circuit that transmits data with the signal pins 410 and 510 do not include electrostatic discharge protection circuitry. Therefore, the data transmission loss is not reduced and significantly high data rates are achieved.

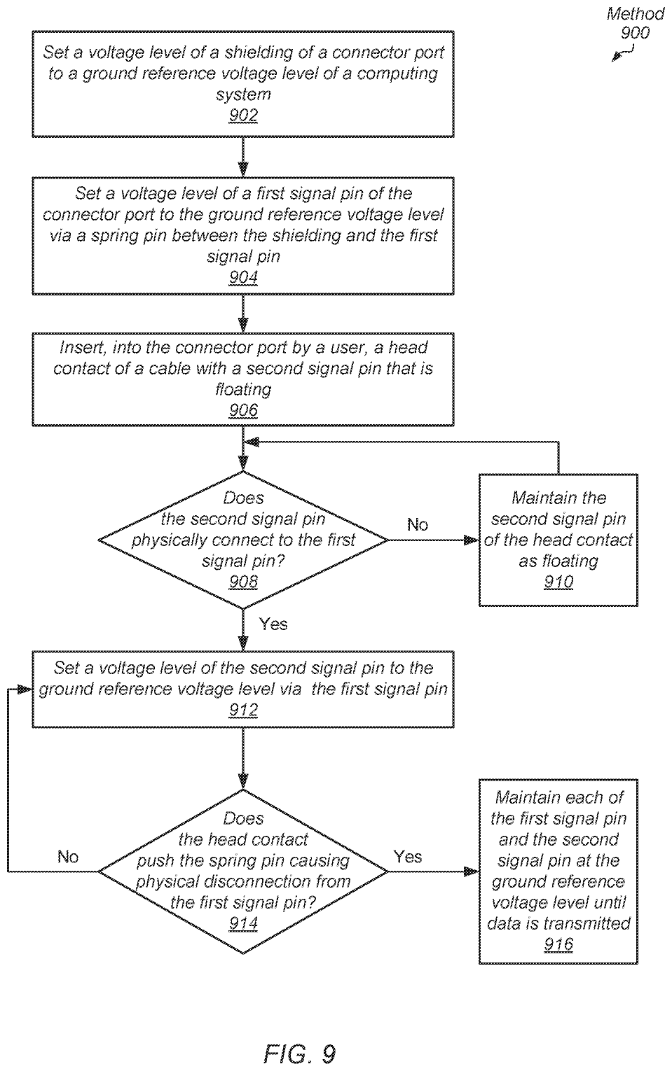

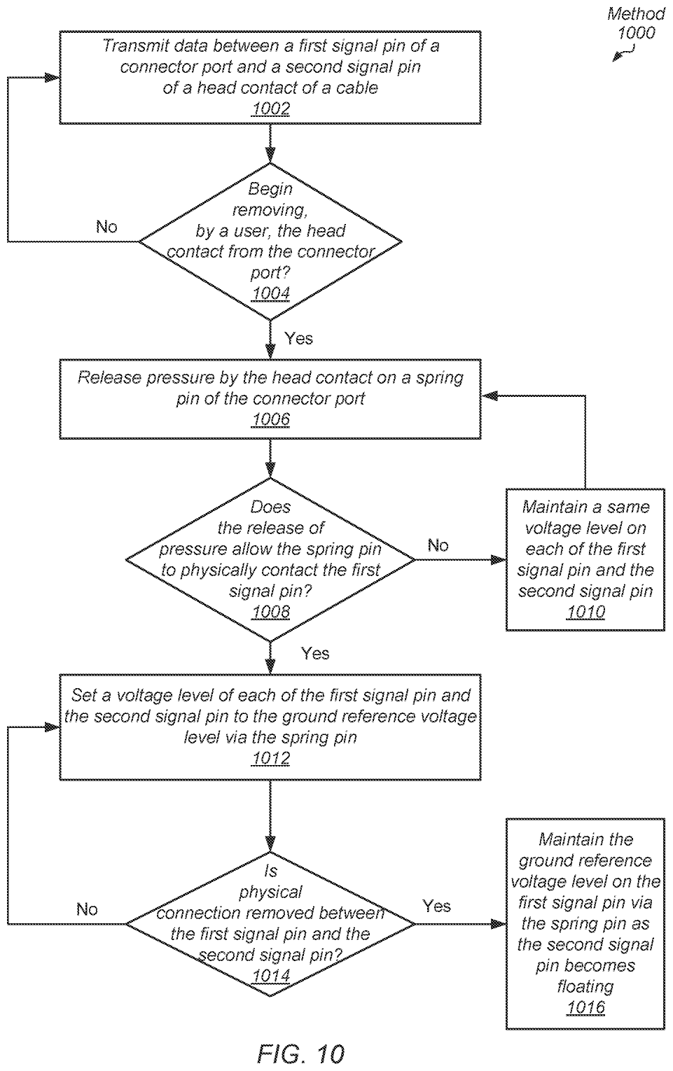

FIG. 9 is a generalized diagram of one implementation of a method 900 for efficiently providing input/output port protection from electrostatic discharge events. For purposes of discussion, the steps in this implementation (as well as in FIG. 10) are shown in sequential order. However, in other implementations some steps occur in a different order than shown, some steps are performed concurrently, some steps are combined with other steps, and some steps are absent.

A voltage level of a shielding (or metal shell) of a connector port is set to a ground reference voltage level of a computing system (block 902). For example, the connector port is embedded in an edge of the printed circuit board and a ground reference voltage level is routed to the shielding of the connector port. A voltage level of a first signal pin of the connector port is set to the ground reference voltage level via a spring pin between the shielding and the first signal pin (block 904). A user inserts, into the connector port, a head contact of a cable with a second signal pin that is floating (block 906). For example, the head contact and the cable are a link between the connector port and a peripheral device. The link is used to connect a display monitor, a Universal Serial Bus (USB) data storage device, or other.

If the second signal pin does not physically connect to the first signal pin (“no” branch of the conditional block 908), then the second signal pin of the head contact remains as a floating signal (block 910), and control flow of method 900 returns to conditional block 908. However, if the second signal pin becomes physically connected to the first signal pin (“yes” branch of the conditional block 908), then the first signal pin sets a voltage level of the second signal pin to the ground reference voltage level (block 912.) For example, due to the physical connection with the first signal pin, the second signal pin is electrically connected to the ground reference voltage level of the printed circuit board through the first signal pin, the spring pin, and the metal shell shielding of the connector port.

If the body or housing of the head contact does not push the spring pin causing physical disconnection from the first signal pin (“no” branch of the conditional block 914), then control flow of method 900 returns to block 912 where the first signal pin sets the voltage level of the second signal pin to the ground reference voltage level. Otherwise, if the body or housing of the head contact pushes the spring pin causing physical disconnection from the first signal pin (“yes” branch of the conditional block 914), then each of the first signal pin and the second signal pin remains at the ground reference voltage level until data is transmitted (block 916).

FIG. 10 is a generalized diagram of one implementation of a method 1000 for efficiently providing input/output port protection from electrostatic discharge events. Data is transmitted between a first signal pin of a connector port and a second signal pin of a head contact of a cable (block 1002). For example, an external peripheral device transfers data with a processing unit on a printed circuit board or card. Examples of the peripheral device are a display monitor, a USB device, or other. The connector port and the head contact have signal pins that transfer the data while interface circuitry supports the corresponding communication protocol. In various implementations, the interface circuitry does not include electrostatic discharge protection circuitry, which allows higher data rates to be achieved.

If a user does not begin removing the head contact from the connector port (“no” branch of the conditional block 1004), then control flow of method 1000 returns to block 1002 where the head contact and the connector port transfer data between using their signal pins. However, if the user begins removing the head contact from the connector port (“yes” branch of the conditional block 1004), then the head contact releases pressure on a spring pin of the connector port (block 1006). If the release of pressure does not allow the spring pin to physically contact the first signal pin (“no” branch of the conditional block 1008), then control flow of method 1000 returns to the block 1006 where the head contact releases pressure on the spring pin of the connector port. Otherwise, if the release of pressure does allow the spring pin to physically contact the first signal pin (“yes” branch of the conditional block 1008), then the spring pin sets a voltage level of each of the first signal pin and the second signal pin to the ground reference voltage level (block 1012). For example, the spring pin is now physically connected to each of the first signal pin and the metal shielding of the connector port. The metal shielding of the connector port is physically connected to a route on the printed circuit board that is electrically connected to the ground reference voltage level.

If the removal of the head contact has not yet caused physical connection to be removed between the first signal pin and the second signal pin (“no” branch of the conditional block 1014), then control flow of method 1000 returns to the block 1012 where the spring pin sets the voltage level of each of the first signal pin and the second signal pin to the ground reference voltage level. Otherwise, if the removal of the head contact has caused physical connection to be removed between the first signal pin and the second signal pin (“yes” branch of the conditional block 1014), then the ground reference voltage level on the first signal pin is maintained via the spring pin as the second signal pin becomes floating (block 1016).

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high level programming language such as C, or a design language (HDL) such as Verilog, VHDL, or database format such as GDS II stream format (GDSII). In some cases the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

1. An apparatus comprising:
a first plurality of signal pins comprised within a shell mounted on a printed circuit board, wherein:
the shell is electrically connected to a ground reference voltage level of the printed circuit board; and
at least a first signal pin of the first plurality of signal pins is electrically connected to the ground reference voltage level via a spring pin between the shell and the first signal pin.

2. The apparatus as recited in claim 1, wherein one or more of the first plurality of signal pins are electrically connected to a functional block on the printed circuit board.

3. The apparatus as recited in claim 1, wherein:
the spring pin comprises stainless steel; and
the first signal pin comprises copper.

4. The apparatus as recited in claim 1, wherein the apparatus is configured to receive a head contact of a cable comprising a second plurality of pins that includes at least a second signal pin that is floating.

5. The apparatus as recited in claim 4, wherein the second signal pin is set to the ground reference voltage level, in response to the second signal pin being physically connected to the first signal pin.

6. The apparatus as recited in claim 4, wherein the spring pin is configured to be pushed by the head contact causing physical disconnection of the spring pin from the first signal pin.

7. The apparatus as recited in claim 6, wherein each of the first signal pin and the second signal pin is configured to transmit data, in response to the spring pin being disconnected from the first signal pin.

8. A method comprising:
receiving, by a shell of a connector port, a ground reference voltage level of a printed circuit board;
receiving, by a first signal pin of a first plurality of signal pins of the connector port, the ground reference voltage level via a spring pin of the connector port between the shell and the first signal pin.

9. The method as recited in claim 8, further comprising conveying one or more of the first plurality of signal pins to a functional block on the printed circuit board.

10. The method as recited in claim 8, wherein:
the spring pin comprises stainless steel; and
the first signal pin comprises copper.

11. The method as recited in claim 8, further comprising receiving, by the connector port, a head contact of a cable comprising a second plurality of pins that includes at least a second signal pin that is floating.

12. The method as recited in claim 11, further comprising receiving, by the second signal pin, the ground reference voltage level, in response to the second signal pin being physically connected to the first signal pin.

13. The method as recited in claim 11, further comprising the spring pin being pushed by the head contact causing physical disconnection of the spring pin from the first signal pin.

14. The method as recited in claim 13, wherein, in response to the spring pin being disconnected from the first signal pin, the method further comprises transmitting data by each of the first signal pin and the second signal pin.

15. A computing system comprising:
an integrated circuit mounted on a printed circuit board, wherein the integrated circuit comprises:
one or more functional blocks; and
an input/output interface comprising a connector port;
a peripheral device; and
a link between the peripheral device and the connector port comprising a head contact of a cable;
wherein the connector port comprises:
a first plurality of signal pins comprised within a shell mounted on the printed circuit board, wherein the shell is electrically connected to a ground reference voltage level of the printed circuit board; and
at least a first signal pin of the first plurality of signal pins is electrically connected to the ground reference voltage level via a spring pin between the shell and the first signal pin.

16. The computing system as recited in claim 15, wherein one or more of the first plurality of signal pins are electrically connected to a given one of the one or more functional blocks.

17. The computing system as recited in claim 15, wherein:
the spring pin comprises stainless steel; and
the first signal pin comprises copper.

18. The computing system as recited in claim 15, wherein the connector port is configured to receive the head contact of a cable comprising a second plurality of pins that includes at least a second signal pin that is floating.

19. The computing system as recited in claim 18, wherein the second signal pin is set to the ground reference voltage level, in response to the second signal pin being physically connected to the first signal pin.

20. The computing system as recited in claim 18, wherein the head contact is configured to push the spring pin causing physical disconnection of the spring pin from the first signal pin.

21. An apparatus comprising:
a first plurality of signal pins comprised within a head contact of a cable, wherein:
at least a first signal pin of the first plurality of signal pins is floating prior to the head contact being physically connected to a connector port mounted on a printed circuit board; and
the first signal pin is electrically connected to a ground reference voltage level of the printed circuit board, in response to:
the first signal pin being physically connected to a second signal pin of a second plurality of signal pins of the connector port; and
the head contact not yet being fully inserted in a shell of the connector port.

22. The apparatus as recited in claim 21, wherein the second signal pin of the connector port is electrically connected to the ground reference voltage level of the printed circuit board via a spring pin between the shell of the connector port and the second signal pin prior to the head contact being fully inserted in the shell of the connector port.

23. The apparatus as recited in claim 22, wherein each of the first signal pin and the second signal pin is electrically connected to the ground reference voltage level of the printed circuit board via the spring pin prior to the head contact being fully inserted in the shell of the connector port.

24. The apparatus as recited in claim 23, wherein:
the spring pin comprises stainless steel; and
one or more of the first signal pin and the second signal pin comprises copper.

25. The apparatus as recited in claim 22, wherein the head contact of the cable is configured to push the spring pin causing physical disconnection of the spring pin from the second signal pin of the connector port.

26. The apparatus as recited in claim 25, wherein each of the first signal pin and the second signal pin is configured to transmit data, in response to the spring pin being disconnected from the second signal pin of the connector port.

27. The apparatus as recited in claim 26, wherein one or more of the first plurality of signal pins of the head contact are electrically connected to a functional block on the printed circuit board via the second plurality of signal pins of the connector port.
